(19) United States
(12) Patent Application Publication
(10) Pub. No.: US 2006/0135688 A1
(43) Pub. Date: Jun. 22, 2006

(54) Powder coating compositions

(76) Inventors: Robin R. Gibson, Chester (GB); Alexis J. Toft, Warrington (GB)

Correspondence Address: MAYER, BROWN, ROWE & MAW LLP, 1909 K STREET, N.W., WASHINGTON, DC, 20006, US

(21) Appl. No.: 10/527,837

(22) PCT Filed: Aug. 20, 2003
(86) PCT No.: PCT/GB03/03626

§ 371 Date: Aug. 22, 2005

(30) Foreign Application Priority Data
Sep. 16, 2002 (GB) 0221430.2

(51) Int. Cl. C08K 3/20; C08L 63/00; B32B 27/00

(52) U.S. Cl. 524/783; 523/457

(57) ABSTRACT

A powder coating composition comprises a mixture, in particulate form, of a zeolite and an organic resin, said zeolite containing less than 9 percent water by weight as determined by heating at 800° C. for 1 hour. The zeolite can act as an extender for titanium dioxide in systems containing the latter.

This invention relates to powder coating compositions and in particular to compositions comprising an organic resin and a zeolite.

Powder coating compositions are well known. They comprise powder compositions suitable for forming a coating on a substrate to which they are applied in the form of a powder and the coating is formed on the substrate by heating and fusing the applied powder. They contain essentially no solvent and, hence, there are virtually no emissions during application or curing. The cured film is relatively thin and it therefore necessary to include a relatively high level of pigmentation to achieve satisfactory opacity. The most common pigment used in powder coating compositions is titanium dioxide, but this is expensive. In view of the high level of pigmentation, it is necessary to use pigments with a low oil absorption, in order to minimise any deleterious effects on the properties of the cured film. Hence, it is difficult to reduce the cost of the coating composition by adding materials such as calcium carbonate etc. to extend the titanium dioxide, since such materials generally have a high oil absorption. Materials which have been used to extend titanium dioxide in powder coatings are lithopone and barium sulphate but these are relatively ineffective extenders.

One object of this invention is to provide a powder coating composition which produces a finished coating with desirable properties and is less expensive than compositions based on non-extended titanium dioxide.

According to the invention, a powder coating composition comprises a mixture, in particulate form, of a zeolite and an organic resin, said zeolite containing less than 9 percent water by weight as determined by heating

In general, the empirical formula of a zeolite is
M_{2/n}O·Al₂O₃·xSiO₂·yH₂O
wherein M represents a metallic cation having a valency of n, x indicates the ratio of atoms of silicon to atoms of aluminium and y Indicates the ratio of molecules of water to atoms of aluminium. Many different types of zeolite, with varying ratios of silica to alumina, are known. Commonly, however, M is an alkali metal and a preferred alkali metal is sodium, for economic reasons.

The zeolites used in this invention may have the structure of any of the known zeolites. The structure and characteristics of many zeolites are described in the standard work “Zeolite Molecular Sieves” by Donald W. Breck, published by Robert E. Krieger Publishing

Company. Usually, the value of x in the above empirical formula is in the range 1.5 to 10. The value of y, which represents the amount of water contained in the voids of the zeolite, can vary widely. In anhydrous material y=0 and, in fully hydrated zeolites, y may be up to 5. However, for zeolites which are useful in the current invention, the value of y is such that the water content of the zeolite is less than 9 percent by weight, as determined by heating at 800° C. for 1 hour.

Zeolites useful in this invention may be based on naturally-occurring or synthetic aluminosilcates and the preferred forms of zeolite have the structure known as zeolite P or zeolite A. Particularly preferred forms of zeolite are those disclosed in EP-A-0 384 070, EP-A-0 565 364, EP-A-0 697 010, EP-A-0 742 780, WO-A-96/14270, WO-A-96/34828 and WO-A-97/06102, the entire contents of which are incorporated herein by this reference. The zeolite P described in EP-A-0 384 070 has the empirical formula given above in which M represents an alkali metal and x has a value up to 2.66, preferably in the range 1.8 to 2.66, and which is particularly useful in the present invention.

The amount of water, determined by heating at 800° C. for 1 hour, (“total water”) present in the zeolite used in the invention is below 9 percent by weight, but is preferably less than 8.5 percent by weight. More preferably, the total water in the zeolite is less than 7 percent by weight.

The water present in the zeolite can produce undesirable effects if it is released during fusion of the coating. An estimate of water which may be released during fusion of the coating can be obtained by heating the zeolite at 105° C. for 4 hours. The water loss under these conditions (“moisture content”) should preferably be below 2 percent by weight. More preferably, the moisture content of the zeolite is below 1 percent by weight.

The zeolite preferably has a weight mean particle size as determined by Malvern Mastersizer™ in the range 0.5 μm to 6.0 μm. Preferably, the weight mean particle size is in the range 1.0 μm to 4.0 μm.

The organic resin which is present in the powder coating composition can be any organic resin which is suitable for preparing powder coatings. It may be a thermoplastic resin or a thermosetting resin.

Suitable thermoplastic resins include plasticised poly(vinyl chloride), polyamides, polyolefins and poly(vinylidene fluoride). Preferably, the plasticised poly(vinyl chloride) is a homopolymer of vinyl chloride. Preferred polyamides are nylon-11 and nylon-12.

Polyethylene and polypropylene, which may be modified by grafting of carboxylic acid or anhydride groups onto the polymer backbone, are suitable polyolefins.

Many thermosetting resins have been used in powder coatings and may be used in the compositions of this invention. Suitable resins include epoxy resins, polyester resins, hybrid epoxy-polyester resins, urethane resins and acrylic resins.

Epoxy resins are characterised by the presence of an epoxide group and the most commonly used resins are diglycidyl ethers of bisphenol A, deriyed from bisphenol A and epichlorohydrin. Such resins are cured after application to a substrate by means of a curing agent, such as a polyamine or a polyamide, and such a curing agent is present in the composition of the invention when epoxy resins are used.

Many polyesters are suitable for use in this invention and are well known in the art of powder coatings. The polyesters are usually prepared from polybasic acids or their esterifiable derivatives and from polyols. Carboxyl-rich and hydroxyl-rich polymers are suitable. Typical polyesters include esters of terephthalic acid, isophthalic acid, trimellitic acid, adipic acid or sebacic acid with ethylene glycol, 1,2-propylene glycol, trimethylol propane, a butanediol, glycerol or tris(hydroxyethyl)isocyanurate. Normally, polyesters are cured after application and preferred curing agents are triglycidyl isocyanurate (TGIC) and hydroxyalkyl amides, such as those sold under the Trademark PRIMID.

The urethane polymers which are used in powder coating compositions are often urethane polyesters. These are typically prepared by reaction of a polyester with a caprolactam-blocked polyisocyanate, this reaction occurring after application of the powder to the substrate. Hence, for these systems, the organic resin consists of a mixture of polyester resin and blocked polyisocyanate. Suitable polyesters are, for example, polyesters of terephthalic acid, isophthalic acid or trimellitic acid with neopentyl glycol. Commonly, these are cured using adducts of isophorone diisocyanate and low molecular weight polyols, such as polyethylene glycols or polypropylene glycols, the adducts being blocked with caprolactam. Other suitable curing agents include caprolactam-blocked toluene diisocyanate.

When powder coating compositions according to the invention additionally contain pigmentary titanium dioxide, the zeolite acts as an extender for the titanium dioxide. A preferred powder coating according to the invention comprises a mixture, in particulate form, of a zeolite, an organic resin and pigmentary titanium dioxide, said zeolite containing less than 9 percent water by weight determined by heating at 800° C. for 1 hour.

When the finished (cured) coating is white, the powder coating according to the invention usually contains from 10 to 40 percent by weight pigmentary titanium dioxide. Preferably, the amount of titanium dioxide present is from 20 to 30 percent by weight of the coating.

Powder coatings which produce a coloured finished coating often contain pigmentary titanium dioxide in addition to at least one coloured pigment. In such systems, the amount of pigmentary titanium dioxide is frequently in the range 2 to 20 weight percent of the composition and commonly in the range 5 to 15 weight percent of the composition.

The amount of zeolite in white or coloured compositions is usually up to 50 percent of the combined weight of zeolite and pigmentary titanium dioxide. Preferably, the amount of zeolite is up to 30 percent of the combined weight of zeolite and pigmentary titanium dioxide in the composition. For optimum properties (i.e. good opacity at an economical cost) the amount of zeolite is usually from 10 to 25 percent of the combined weight of zeolite and titanium dioxide.

Thus, a typical white powder coating according to the invention comprises up to 20 weight percent zeolite and, more commonly, from 1 to 10 weight percent zeolite. A typical coloured powder coating composition comprises up to 10 weight percent of zeolite and, more commonly, from 0.5 to 8 percent by weight zeoliie.

In addition to the zeolite and titanium dioxide, coloured powder coating compositions according to the invention also comprise at least one coloured pigment. Suitable pigments may be organic or inorganic pigments, as conventionally used in powder coating compositions. In view of the fact that the powder coatings are heated after application, suitable pigments usually need to be stable up to a temperature of at least 150° C. and preferably up to 250° C. Iron oxides and heat-stable organic pigments have been successfully used.

The powder coating compositions of the invention frequently contain additional components often used in such compositions, such as catalysts and curing accelerators, flow control additives, UV stabilisers, antifoams and matting agents.

It is generally necessary to mix intimately the ingredients of the powder coating compositions of the invention in order to achieve a satisfactorily homogeneous finished coating. Commonly used methods of producing an intimate mixture indude melt-mixing and dry blending.

In the melt-mixing process, dry ingredients (zeolite, organic resin and any other components) are weighed into a batch mixer such as a high intensity impeller mixer, a medium intensity plough mixer or a tumble mixer. Mixing times depend upon the equipment used. For high intensity mixers, the mixing time is usually in the range 1 to 5 minutes and the mixing time in a tumble mixer is frequently in the range 30 to 60 minutes. The premix thus formed is then compounded together with any liquid ingredients in a high shear extruder such as a single screw extruder (e.g. Buss Ko-kneader) or a twin screw extruder. It is important to ensure that the combination of temperature of the mixture and residence time for thermosetting compositions is such that little or no curing takes place in the extruder, although the temperature is usually slightly above the melting point of the organic resin. The appropriate processing temperature is chosen to suit the resin present in the composition, but is usually in the range 60 to 140° C. Residence time in the extruder is usually in the range 0.5 to 2 minutes. The extruded material is usually cooled rapidly by water cooling and broken Into pellets or chips with a size of about 5 to 10 mm. These pellets or chips are then ground to an appropriate particle size using conventional techniques. Frequently, thermoplastic resins need to be ground using cryogenic techniques.

The powder coating compositions can also be prepared by dry blending and this technique is particularly suitable where the organic resin is plasticised poly(vinyl chloride). All the ingredients are agitated in a high speed mixer at an elevated temperature in order to achieve intimate mixing.

The average particle size of the powder coating compositions prepared by grinding the melt-mixed material or by dry blending depends to some extent on the method by which the powder is to be applied and the thickness of the coating to be applied. When the powder is to be applied by electrostatic spraying the average particle size is usually in the range 10 to 75 μm. For fluidised bed coating and thicker coatings, the particle size of the powder coating compositions is generally in the range 40 to 200 μm.

The powder coating compositions according to the invention are suitable for coating on a substrate using any method normally used for coating substrates with powder coatings. The precise nature of the organic resin will often determine the optimum conditions for application.

The powder coating composition can be applied to a substrate using a fluid bed in which the particles of powder coating composition are fluidised and the substrate is introduced into the fluidised bed. An electrostatic fluidised bed process using ionised air can also be used. The substrate is earthed and, consequently, the charged powder is attracted to the substrate.

Very commonly, powder coating compositions are applied by electrostatic spray coating. Typically, the powder coating composition is stored in a fluidised-bed reservoir and passed into an air stream where it is charged by passing through, for example, a corona discharge field.

The finished coating is formed by fusing the powder. For thermoplastic resins the applied powder coating composition must be heated to a temperature above the melting point of the resin so that the particles melt and fuse together. For thermosetting resins, the coating is heated to a temperature at which the resin or its precursors are cured into a coating which flows sufficiently to produce a uniform coating on the substrate. The appropriate temperature depends principally upon the actual resin or resins used and is readily determined by a person skilled in the art of powder coatings.

The following tests have been used to measure the parameters which characterise this invention.

Total Water Content

An accurately weighed sample of zeolite (approximately 2.5 g) is placed in a silica crucible and heated in a muffle furnace at 800° C. for 1 hour. The sample is cooled to room temperature in a sealed desiccator. The loss in weight is measured and expressed as a percentage of the original weight.

Moisture Content

An accurately weighed sample of zeolite (approximately 3 g) was placed in a weighing dish and heated in an oven at 105° C. for 4 hours. The sample was cooled to room temperature in a sealed desiccator. The loss in weight was measured and expressed as a percentage of the original weight.

Weight Mean Particle Size

The weight mean particle size is determined using a Malvern Mastersizer™ model X, with a lens range up to 300 mm RF and MS17 sample presentation unit. This instrument, made by Malvern Instruments, Malvern, Worcestershire, uses the principle of Mie scattering, utilising a low power He/Ne laser. Before measurement the sample is dispersed ultrasonically in water for 7 minutes to form an aqueous suspension. This suspension is stirred before it is subjected to the measurement procedure outlined in the instruction manual for the instrument, utilising the 300 mm RF lens range in the detector system. The Malvern Mastersizer™ measures the weight particle size distribution of the inorganic material or reference material. The weight mean particle size (d₅₀) or 50 percentile is readily obtained from the data generated by the instrument.

Oil Absorption

The oil absorption is determined by the ASTM spatula rub-out method (American Society of Test Material Standards D 281). The test is based on the principle of mixing linseed oil with the zeolite by rubbing with a spatula on a smooth surface until a stiff putty-like paste is formed which will not break or separate when it is cut with a spatula. The oil absorption is then calculated from the volume of oil (V cm³) used to achieve this condition and the weight, W. in grams, of zeolite by means of the equation:
Oil absorption=(V×100)/W, i.e. expressed in terms of cm³ oil/100 g zeolite.
60° Gloss

The gloss (60°) values of the cured coatings were measured using a Sheen Tri-microgloss 20-60-85 (160) unit. Gloss is a measurement of the intensity of a reflected incident beam, where the incident beam is projected at 60° to the perpendicular of the coating plane as described in ASTM D 523.

Colour

Colour was determined using an X-rite 938 Spectrodensiometer. This unit measures the L*, a*, b* tristimulus values as described using the CIE 1976 L*, a*, b* (CIELAB) Colour Space where the L* axis describes lightness, a* describes the axis from redness (positive a* values) to greenness (negative a* values) and b* describes the axis from yellowness (positive b* values) to blueness (negative b* values).

Contrast Ratio

The contrast ratio is measured using an X-rite 938 Spectrodensiometer. The contrast ratio is the extent to which a coating hides or obscures the contrasting features of a test substrate. In this instance, contrast ratio is expressed photometrically as the ratio of the luminous (CIE-Y) reflection of the coating measured over a black substrate and the luminous (CIE-Y) reflection of the same coating measured over a white substrate.

Impact

The impact resistance of coatings was conducted using ASTM D2794, with indentation to 2.5 mm at 223 cm/kg (40 lb/ft).

Cupping Test

This test was carried out using an Erichsen Cupping tester as described in BS 3900 E4 which forces a spherical steel ball into the uncoated side of a metallic substrate until the depth of the cup is no more that 18 mm. The depth of indentation at which the coating was visually observed to crack or split is recorded.

UV Stability

UV stability was determined through exposure of cured powder coating samples to emissions from a Xenon lamp with daylight filter for given periods (1000 or 2000 hrs continuous). Equipment used was Q-Sun 1000 Zenon Lamp unit with daylight filter under conditions of irradiance at 0.8 W/m² at 420 nm and temperature of 50° C.

The invention is illustrated by the following non-limiting examples.

### EXAMPLES

### Example 1

A variety of epoxy-polyester powder coating compositions was prepared according to the formulations given in Table 1 below. Sample A was a standard composition containing titanium dioxide and Samples B to D were similar but various proportions of the titanium dioxide had been substituted by a Zeocros™ E110, a zeolite sold by INEOS Silicas Limited, Warrington, England. This is a zeolite MAP (maximum aluminium P-type) with an average particle size of 2 μm by Malvern Mastersizer™, a Total Water Content of 8.0 percent by weight and an oil absorption

TABLE 1

| | Sample A | Sample B | Sample C | Sample C |
|---|---|---|---|---|
| Epoxy resin | 32.5 | 32.5 | 32.5 | 32.5 |
| (Vantico 6064)¹ | | | | |
| 50/50 Polyester/epoxy | 32.5 | 32.5 | 32.5 | 32.5 |
| resin | | | | |
| (Reafree 6877)² | | | | |
| Flow aid (Resiflow | 0.8 | 0.8 | 0.8 | 0.8 |
| PV88)³ | | | | |
| Benzoin | 0.4 | 0.4 | 0.4 | 0.4 |
| Barytes (Airwhite | 3.8 | 3.8 | 3.8 | 3.8 |
| AW10)⁴ | | | | |
| Titanium dioxide | 30.0 | 27.0 | 22.5 | 15.0 |
| (Kronos 2310)⁵ | | | | |
| Zeolite (Zeocros E110) | — | 3.0 | 7.5 | 15.0 |

¹Available from Vantico Ltd. Ickleton Road, Duxford, Cambridge, UK.
²Available from Cray Valley Products, Waterloo Works, Machen, UK.
³Available from Worlee-Chemie GmbH, VB Hamburg, Siegfried Handt, Grusonstr. 22, Hamburg, Germany
⁴Available from Viaton Industries Ltd., Brassington, Carsington, UK.
⁵Available from Kronos Europe SA/NV, Rue de I'Hopital, Brussels, Belgium.

The amounts in Table 1 are proportions by weight.

The powder coating compositions were prepared as follows. The resins and pigments were dry blended in a 5 litre tumble mixer for 5 minutes. The dry blend was then fed through a hopper and processed through a Prism 16 mm twin screw extruder at 110/60° C. (screw speed 270 rpm at 70% torque). The extrudates were then ground in a Fritsch P14 mill at 18,000 rpm and sieved through a 125 μm sieve to give a powder. having an average particle size of approximately 50 μm.

The powder coating compositions were then applied to clean 15×10 cm aluminium Q-panels by Mitsuba corona discharge gun using 60 kV charge so that the final (post-cure) film thickness was from 60 to 70 μm.

The applied coatings were heated at 180° C. for 10 minutes to cure. The cured coatings were assessed for Gloss, Colour, Contrast Ratio, Impact, and in a Cupping Test and the results are reported in Table 2 below.

TABLE 2

| | | Sample A | Sample B | Sample C | Sample D |
|---|---|---|---|---|---|
| Gloss | | 94 | 91 | 90 | 90 |
| Colour | δL* | std | −0.27 | −0.88 | −1.67 |
| | δa* | std | +0.05 | +0.06 | −0.01 |
| | δb* | std | −0.20 | −0.60 | −0.80 |
| | δE | std | +0.34 | +1.07 | +1.85 |
| Contrast Ratio | 50 μm | 97% | 97% | 96% | 93% |
| | 90 μm | 99% | 99% | 98% | 98% |
| Impact | | 1 | 1 | 1 | 1 |
| (Category) | | | | | |
| Cupping Test | | 7 mm | 7 mm | 7 mm | 7 mm |

The samples were also exposed to UV radiation (see UV Stability test) and the effect of UV exposure on gloss measured. Results are shown in Table 3 below.

TABLE 3

| Exposure | | 0 | 50 | 100 | 260 | 428 | 1000 |
|---|---|---|---|---|---|---|---|
| (hrs) | | | | | | | |
| Gloss | A | 94 | 93 | 87 | 61 | 46 | 18 |
| | B | 91 | 91 | 83 | 62 | 45 | 18 |
| | C | 90 | 89 | 84 | 57 | 41 | 14 |
| | D | 90 | 89 | 81 | 51 | 34 | 9 |

### Example 2

A variety of white polyester-Primid powder coating compositions was prepared according to the formulations given in Table 4 below. Sample E was a standard composition containing titanium dioxide and Samples F to H were similar but various proportions of the titanium dioxide had been substituted by Zeocros™ E110, as used in Example 1.

TABLE 4

| | Sample E | Sample F | Sample G | Sample H |
|---|---|---|---|---|
| Polyester resin | 60 | 60 | 60 | 60 |
| (UCB V7630)⁶ | | | | |
| bis-N,N-dihydroxy- | 3.2 | 3.2 | 3.2 | 3.2 |
| ethyladipamide | | | | |
| (Primid XL-552)⁷ | | | | |
| Flow aid | 0.8 | 0.8 | 0.8 | 0.8 |
| (Resiflow PV88) | | | | |
| Benzoin | 0.2 | 0.2 | 0.2 | 0.2 |
| Barytes | 5.8 | 5.8 | 5.8 | 5.8 |
| (Airwhite AW10) | | | | |
| Titanium dioxide | 30.0 | 27.0 | 22.5 | 15.0 |
| (Kronos 2310) | | | | |
| Zeolite | — | 3.0 | 7.5 | 15.0 |
| (Zeocros E110) | | | | |

⁶Available from UCB (Chem) Ltd., UCB House, 3 George St., Watford, UK
⁷Available from EMS Chemie, Kugelstrasse 22, Mannedorf, Switzerland.

The amounts in Table 4 are proportions by weight.

The powder coating compositions were prepared as follows. The resins and pigments were dry blended in a 5 litre tumble mixer for 5 minutes. The dry blend was then fed through a hopper and processed through a Prism 16 mm twin screw extruder at 110/60° C. (screw speed 270 rpm at 70% torque). The extrudates were then ground in a Fritsch P14 mill at 18,000 rpm and sieved through a 125 μm sieve to give a powder having an average particle size of approximately 50 μm.

The powder coating compositions were then applied to clean 15×10 cm aluminium Q-panels by Mitsuba corona discharge gun using 60 kV charge so that the final (post-cure) film thickness was from 60 to 70 μm.

The applied coatings were heated at 180° C. for 10 minutes to cure. The coatings were assessed for Gloss, Colour, Contrast Ratio, Impact, and in a Cupping Test and the results are reported in Table 5 below.

TABLE 5

| | | Sample E | Sample F | Sample G | Sample H |
|---|---|---|---|---|---|
| Gloss | | 82 | 85 | 88 | 86 |
| Colour | δL* | std | −0.23 | −0.27 | −0.53 |
| | δa* | std | +0.02 | +0.05 | +0.08 |
| | δb* | std | −0.29 | −0.32 | −0.09 |
| | δE | std | +0.37 | +0.42 | +0.54 |
| Contrast Ratio | 50 μm | 98% | 98% | 96% | 96% |
| | 90 μm | 100% | 99% | 98% | 98% |
| Impact | | 3 | 1 | 1 | 1 |
| (Category) | | | | | |
| Cupping Test | | 7 mm | 7 mm | 7 mm | 7 mm |

The samples were also exposed to UV radiation (see UV Stability test) and the effect of UV exposure on gloss measured. Results are shown in Table 6 below.

TABLE 6

| Exposure | | 0 | 54 | 100 | 189 | 267 | 523 | 1000 | 1504 | 2000 |
|---|---|---|---|---|---|---|---|---|---|---|
| (hrs) | | | | | | | | | | |
| Gloss | E | 82 | 84 | 84 | 83 | 84 | 83 | 83 | 82 | 82 |
| | F | 85 | 85 | 85 | 85 | 86 | 84 | 83 | 82 | 81 |
| | G | 88 | 86 | 88 | 87 | 86 | 87 | 87 | 81 | 83 |
| | H | 86 | 87 | 87 | 86 | 86 | 86 | 86 | 84 | 84 |

### Example 3

A variety of coloured polyester-Primid powder coating compositions was prepared according to the formulations given in Table 7 below. Samples I and K were standard coloured compositions and Samples J to L were similar but in each case 25% of the titanium dioxide had been substituted by Zeocros™ E110, as used in Example 1.

TABLE 7

| | Sample I | Sample J | Sample K | Sample L |
|---|---|---|---|---|
| Polyester resin | 60 | 60 | 60 | 60 |
| (UCB V7630) | | | | |
| bis-N,N-dihydroxy | 3.2 | 3.2 | 3.2 | 3.2 |
| ethyladipamide | | | | |
| (Primid XL-552) | | | | |
| Flow aid | 0.8 | 0.8 | 0.8 | 0.8 |
| (Resiflow PV88) | | | | |
| Benzoin | 0.2 | 0.2 | 0.2 | 0.2 |
| Barytes | 5.8 | 5.8 | 5.8 | 5.8 |
| (Airwhite AW10) | | | | |
| Titanium dioxide | 10.0 | 7.5 | 10.0 | 7.5 |
| (Kronos 2310) | | | | |
| Zeolite | — | 2.5 | — | 2.5 |
| (Zeocros E110) | | | | |
| Blue pigment | 3.0 | 3.0 | — | — |
| (Blue BGP)⁸ | | | | |
| Yellow pigment | — | — | 3.0 | 3.0 |
| (Bayferrox Oxide | | | | |
| YW3910)⁹ | | | | |

⁸Available from Albion Chemicals Group, Rawdon House, Green Lane, Yeadon, Leeds, UK.
⁹Available from Bayer plc, Bayer House Strawberry, Newbury, UK.

The amounts in Table 7 are proportions by weight

The powder coating compositions were prepared as follows. The resins and pigments were dry blended in a 5 litre tumble mixer for 5 minutes. The dry blend was then fed through a hopper and processed through a Prism 16 mm twin screw extruder at 110/60° C. (screw speed 270 rpm at 70% torque). The extrudates were then ground in a Fritsch P14 mill at 18,000 rpm and sieved through a 125 μm sieve to give a powder having an average particle size of approximately 50 μm.

The powder coating compositions were then applied to clean 15×10 cm aluminium Q-panels by Mitsuba corona discharge gun using 60 kV charge so that the final (post-cure) film thickness was from 60 to 70 μm.

The applied coatings were heated at 180° C. for 10 minutes to cure. The coatings were assessed for Gloss, Colour, Contrast Ratio, Impact, and in a Cupping Test and the results are reported In Table 8 below.

TABLE 8

| | | Sample I | Sample J | Sample K | Sample L |
|---|---|---|---|---|---|
| Gloss | | 83 | 81 | 84 | 82 |
| Colour | δL* | std | −2.13 | std | −1.98 |
| | δa* | std | +2.26 | std | +0.43 |
| | δb* | std | +0.87 | std | +1.29 |
| | δE | std | +3.23 | std | +2.40 |
| Contrast Ratio | 50 μm | 100% | 100% | 97% | 97% |
| | 90 μm | 100% | 100% | 98% | 98% |
| Impact | | 2 | 2 | 2 | 1 |
| (Category) | | | | | |
| Cupping Test | | 7 mm | 7 mm | 7 mm | 7 mm |

The samples were also exposed to UV radiation (see UV Stability test) and the effect of UV exposure on gloss measured. Results are shown in Table 9 below.

TABLE 9

| Exposure | | 0 | 54 | 100 | 189 | 267 | 523 | 1000 | 1504 | 2000 |
|---|---|---|---|---|---|---|---|---|---|---|
| (hrs) | | | | | | | | | | |
| Gloss | I | 83 | 83 | 84 | 85 | 84 | 83 | 85 | 85 | 82 |
| | J | 81 | 82 | 80 | 83 | 83 | 84 | 82 | 81 | 80 |
| | K | 84 | 84 | 84 | 83 | 83 | 83 | 82 | 80 | 78 |
| | L | 82 | 83 | 84 | 84 | 83 | 83 | 82 | 80 | 78 |

1. The use in a powder coating composition comprising a mixture, in particulate form, of titanium dioxide and an organic resin, of a zeolite as an extender for the titanium dioxide, said zeolite containing less than 9 percent water by weight as determined by heating at 800° C. for 1 hour.

2. A powder coating composition comprising a mixture, in particulate form, of a zeolite and an organic resin, said resin being a plasticised poly(vinyl chloride), a polyamide, poly(vinylidene fluoride), an epoxy resin, a polyester resin, a hybrid epoxy-polyester resin, a urethane resin or an acrylic resin and said zeolite containing less than 9 percent water by weight as determined by heating 800° C. for 1 hour.

3. The use or composition according to claim 1, wherein the zeolite is a zeolite A or a zeolite P.

4. The use or composition according to claim 1, wherein the zeolite contains less than 7 percent by weight water, as determined by heating at 800° C. for 1 hour.

5. The use or composition according to claim 1, wherein the zeolite has a water loss after heating at 105° C. for 4 hours of less than 2 percent by weight.

6. The use or composition according to claim 1, wherein the zeolite has a weight mean particle size in the range 0.5 μm to 6.0 μm.

7. The use or composition according to claim 1, wherein the powder coating composition additionally comprises from 10 to 40 percent by weight pigmentary titanium dioxide.

8. The use or composition according to claim 7, wherein the amount of zeolite present is up to 20 percent by weight of the coating composition.

9. The use or composition according to claim 1, wherein the powder coating composition additionally contains a colored pigment and from 2 to 20 weight percent pigmentary titanium dioxide.

10. The use or composition according to claim 9, wherein the amount of zeolite present in the composition is from 0.5 to 8 percent by weight of the coating composition.

11. The use or composition according to claim 1, wherein the particles of the powder coating composition have an average size in the range 10 to 75 μm.

12. The use or composition according to claim 1, wherein the particles of the powder coating composition have an average size in the range 40 to 200 μm.

13. The use according to claim 1 in which the organic resin is plasticised poly(vinyl chloride), a polyamide, a polyolefin, poly(vinylidene fluoride), an epoxy resin, a polyester resin, a hybrid epoxy-polyester resin, a urethane resin or an acrylic resin.

14. A method of preparing a powder coating composition comprising forming an intimate mixture of an organic resin and a zeolite, said resin being a plasticised poly(vinyl chloride), a polyamide, poly(vinylidene fluoride), an epoxy resin, a polyester resin, a hybrid epoxy-polyester resin, a urethane resin or an acrylic resin and said zeolite contains less than 9 percent water by weight as determined by heating at 800° C. for 1 hour.
